(19) United States
(12) Patent Application Publication
(10) Pub. No.: US 2025/0365127 A1
(43) Pub. Date: Nov. 27, 2025

(54) CONFIDENTIAL INFORMATION PROCESSING SYSTEM, CONFIDENTIAL INFORMATION PROCESSING METHOD AND COMPUTER READABLE MEDIUM

(71) Applicant: Mitsubishi Electric Corporation, Tokyo (JP)

(72) Inventor: Ryo HIROMASA, Tokyo (JP)

(73) Assignee: Mitsubishi Electric Corporation, Tokyo (JP)

(21) Appl. No.: 19/288,410

(22) Filed: Aug. 1, 2025

Related U.S. Application Data
(63) Continuation of application No. PCT/JP2023/012095, filed on Mar. 27, 2023.

(51) Int. Cl. H04L 9/00; H04L 9/08

(52) U.S. Cl. CPC H04L 9/008; H04L 9/0822; H04L 9/0869

(57) ABSTRACT

A key generation device (200) generates an encryption key PK, a decryption key SK and a homomorphic operation key EVK. An encryption device (300) generates ciphertext data C_{DPK} (m) by encrypting plaintext data m with the encryption key PK. A denial random number generation device (400) takes the encryption key PK and the ciphertext data C_{DPK} (m) as input to generate denial random number data r* for denying the disclosure of plaintext data m. A homomorphic operation device (500) generates post-homomorphic operation ciphertext data C_{MPK} (M) by performing a homomorphic operation on the calculation result of the plaintext data with the homomorphic operation key EVK. A decryption device (600) decrypts the post-homomorphic operation ciphertext data C_{MPK} (M).

### CROSS REFERENCE TO RELATED APPLICATION

This application is a Continuation of PCT International Application No. PCT/JP2023/012095, filed on Mar. 27, 2023, which is hereby expressly incorporated by reference into the present application.

### TECHNICAL FIELD

The present disclosure relates to a confidential information processing system, a confidential information processing method and a confidential information processing program.

### BACKGROUND ART

Homomorphic encryption is a cryptographic technique that allows data to be performed analysis processing while the data remains encrypted. While cloud services have become widely used, it is conceivable to store data on the cloud in an encrypted state due to concerns over cracking or the reliability of the cloud. Homomorphic encryption is a technique that allows use of cloud services without impairing security since operations can be performed on encrypted data without decrypting the data.

A function to prevent forced disclosure of data encrypted in a ciphertext by a privileged user, such as the government, in order to enhance the security of homomorphic encryption is deniability.

An encryption algorithm in general public key cryptographic technologies uses public key data and random number data to encrypt plaintext data. Since the public key data is public information, when the plaintext data and the random number data are determined, ciphertext data is determined uniquely. Deniability is a property that can generate random number data to encrypt data different from plaintext data that is actually encrypted into certain ciphertext data in the ciphertext data. By this property, a user can generate random number data which can encrypt false data in ciphertext data that is stored by the user so as to delegate the analysis processing to a cloud service. This makes it possible to escape from forced disclosure of data when the disclosure of the plaintext data is forced by a privileged user.

Non-Patent Literature 1 discloses a first configuration example of homomorphic encryption that satisfies deniability.

### CITATION LIST

### Non-Patent Literature

Non-Patent Literature 1: Shweta Agrawal, Shafi Goldwasser, and Saleet Mossel., “Deniable Fully Homomorphic Encryption from LWE”, In CRYPTO, pages 641-670, 2021.
Non-Patent Literature 2: Adriana Lopez-Alt, Eran Tromer, and Vinod Vaikuntanathan, “On-the-Fly Multiparty Computation on the Cloud via Multikey Fully Homomorphic Encryption”, In STOC, pages 1219-1234, 2012.

### SUMMARY OF INVENTION

### Technical Problem

The homomorphic encryption with deniability disclosed in Non-Patent Literature 1 can perform analysis processing only between ciphertext data that are encrypted with the same key. As a result, when conducting analysis processing using data of various users in a cloud service employing the deniable homomorphic encryption disclosed in Non-Patent Literature 1, it is necessary to share a key between users; therefore, confidentiality of data cannot be guaranteed between users.

The purpose of the present disclosure is to realize deniable homomorphic encryption where data can be encrypted by use of different keys by each user.

### Solution to Problem

The confidential information processing system according to the present disclosure includes:
a key generation device to generate an encryption key PK, a decryption key SK, and a homomorphic operation key EVK;
an encryption device to generate ciphertext data C_{DPK} (m) by encrypting plaintext data m with the encryption key PK;
a denial random number generation device to generate denial random number data r* for denying disclosure of the plaintext data m by using the encryption key PK and ciphertext data C_{DPK} (m) as input;
a homomorphic operation device to generate post-homomorphic operation ciphertext data C_{MPK} (M) by performing a homomorphic operation on a calculation result of the plaintext data with the homomorphic operation key EVK; and
a decryption device to decrypt the post-homomorphic operation ciphertext data.

### Advantageous Effects of Invention

In a confidential information processing system according to the present disclosure, it is possible to detect substitution or impersonation of an intended person by realizing continuous confidential information processing unconsciously for the intended person

### BRIEF DESCRIPTION OF DRAWINGS

FIG. 1 is a diagram illustrating an example of a system configuration of a confidential information processing system according to First Embodiment;

FIG. 2 is a block diagram illustrating a configuration of a key generation device according to First Embodiment;

FIG. 3 is a block diagram illustrating a configuration of an encryption device according to First Embodiment;

FIG. 4 is a block diagram illustrating a configuration of a denial random number generation device according to First Embodiment;

FIG. 5 is a block diagram illustrating a configuration of a homomorphic operation device according to First Embodiment;

FIG. 6 is a block diagram illustrating a configuration of a decryption device according to First Embodiment;

FIG. 7 is a flowchart illustrating an operation of each device in the confidential information processing system according to First Embodiment;

FIG. 8 is a flowchart illustrating a homomorphic operation of the confidential information processing system according to First Embodiment;

FIG. 9 is a flowchart illustrating a homomorphic operation of the confidential information processing system according to First Embodiment;

FIG. 10 is a diagram illustrating an example of a hardware configuration of each device in the confidential information processing system according to First Embodiment; and

FIG. 11 is a diagram illustrating an example of a hardware configuration of each device in the confidential information processing system according to a variation of First Embodiment.

### DESCRIPTION OF EMBODIMENTS

Hereinafter, description will be made on the present embodiment using diagrams. In each diagram, the same or the corresponding parts are denoted by the same reference signs. In description of the embodiment, explanation of the same or the corresponding parts is appropriately omitted or simplified. The arrows in the diagrams primarily indicate flows of data or flows of processing.

### First Embodiment

### ***Description of Configuration***

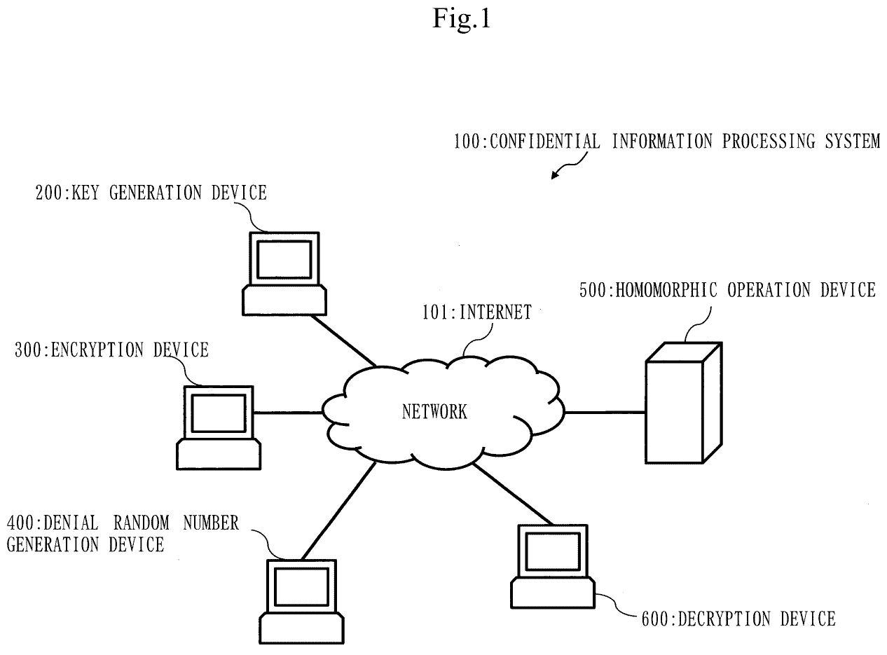

FIG. 1 is a diagram illustrating an example of a system configuration of the confidential information processing system 100 according to the present embodiment.

The confidential information processing system 100 is equipped with a key generation device 200, an encryption device 300, a denial random number generation device 400, a homomorphic operation device 500 and a decryption device 600.

The internet 101 is a communication channel connecting the key generation device 200, a plurality of the encryption devices 300, the denial random number generation device 400, the homomorphic operation device 500 and the decryption device 600. The internet 101 is an example of a network. Instead of the internet 101, other types of networks may be used.

The key generation device 200 is, for example, a PC. PC is an abbreviation for Personal Computer.

The key generation device 200 generates an encryption key used for encryption, a homomorphic operation key used in homomorphic operations, and a decryption key used for decrypting ciphertext data. The key generation device 200 transmits the encryption key to the encryption device 300 and the denial random number generation device 400 via the internet 101, transmits the homomorphic operation key to the homomorphic operation device 500, and transmits the decryption key to the decryption device 600. These keys may also be transmitted directly, by mail or the like. Since the decryption key is confidential information, the decryption key is stored inside the key generation device 200 and the decryption device 600 so as not to leak out.

The encryption device 300 generates ciphertext data by encrypting plaintext data with the encryption key. The encryption device 300 generates ciphertext data by encrypting plaintext data using a single encryption key. The encryption device 300 is, for example, a PC. The encryption device 300 generates ciphertext data by encrypting plaintext data obtained from sensors and the like in factories with the encryption key stored. The encryption device 300 transmits the ciphertext data to the homomorphic operation device 500.

The denial random number generation device 400 generates denial random number data to deny disclosure of plaintext data by using the encryption key and the ciphertext data as input. The denial random number generation device 400 is, for example, a PC. The denial random number generation device 400 also functions as an encryption key storage device that receives the encryption key transmitted from the key generation device 200, and stores the encryption key.

The denial random number generation device 400 generates denial random number data from the ciphertext data, the plaintext data and the random number data transmitted from the encryption device 300, and stores the denial random number data.

The homomorphic operation device 500 generates post-homomorphic operation ciphertext data obtained by performing homomorphic operation on the calculation result of the plaintext data using the homomorphic operation key and the ciphertext data as input. The homomorphic operation device 500 is, for instance, a computing device with large-capacity storage medium. The homomorphic operation device 500 also functions as a data storage device. That is, upon receiving a storage request of ciphertext data from the encryption device 300, the homomorphic operation device 500 stores those pieces of ciphertext data.

The homomorphic operation device 500 also functions as a device that performs homomorphic operation on the stored ciphertext data. That is, the homomorphic operation device 500 generates ciphertext data (post-homomorphic operation ciphertext data) being the result of operation on the plaintext data of the ciphertext data from a stored homomorphic operation key and stored ciphertext data, and transmits the post-homomorphic operation ciphertext data to the decryption device 600. The stored homomorphic operation key is the homomorphic operation key stored in the homomorphic operation device 500. The stored ciphertext data is the ciphertext data stored in the homomorphic operation device 500.

The decryption device 600 decrypts the post-homomorphic operation ciphertext data. The decryption device 600 is, for example, a PC. The decryption device 600 also functions as a decryption key storage device, which receives the decryption key transmitted from the key generation device 200 and stores the decryption key.

The decryption device 600 is also a PC that operates as a ciphertext data decryption device to acquire operation results by receiving the ciphertext data (post-homomorphic operation ciphertext data) transmitted from the homomorphic operation device 500, and decrypting the ciphertext data with the decryption key stored.

Moreover, any of the key generation device 200, the encryption device 300, the denial random number generation device 400, the homomorphic operation device 500 and the decryption device 600 may be equipped in the same PC at the same time. Hereinafter, the configuration of the present embodiment will be described.

As illustrated in FIG. 1, the confidential information processing system 100 is equipped with the key generation device 200, the encryption device 300, the denial random number generation device 400, the homomorphic operation device 500 and the decryption device 600. Hereinafter, the configurations of the key generation device 200, the encryption device 300, the denial random number generation device 400, the homomorphic operation device 500 and the decryption device 600 will be described in series.

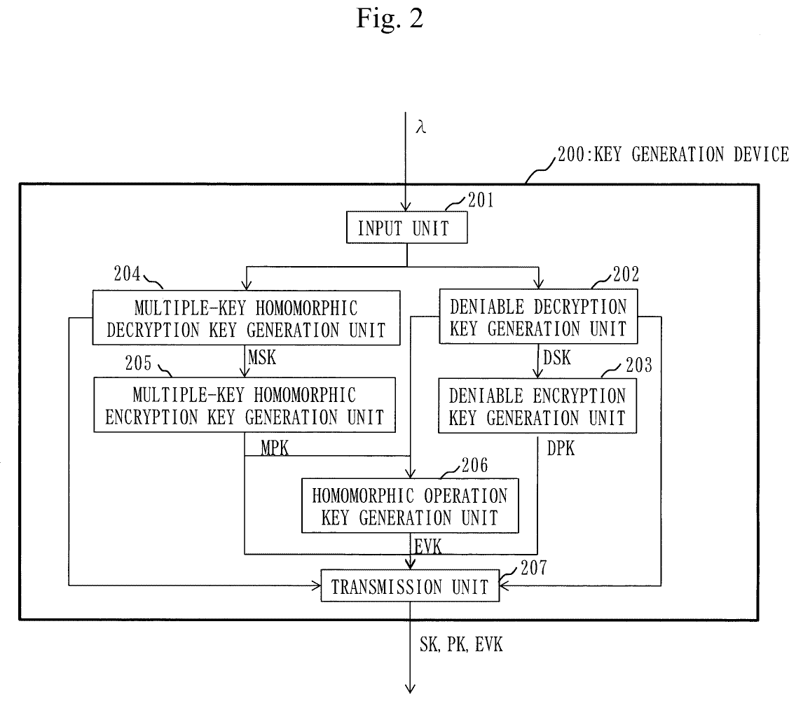

FIG. 2 is a block diagram illustrating the configuration of the key generation device 200 according to the present embodiment.

As illustrated in FIG. 2, the key generation device 200 is equipped with an input unit 201, a deniable decryption key generation unit 202, a deniable encryption key generation unit 203, a multiple-key homomorphic decryption key generation unit 204, a multiple-key homomorphic encryption key generation unit 205, a homomorphic operation key generation unit 206 and a transmission unit 207, as functional elements.

Furthermore, although it is not illustrated, the key generation device 200 is equipped with a storage unit that stores data used in each part of the key generation device 200.

The input unit 201 receives a security parameter λ, and transmits the security parameter λ to the deniable decryption key generation unit 202 and the multiple-key homomorphic decryption key generation unit 204.

The deniable decryption key generation unit 202 generates a deniable decryption key DSK using the security parameter λ received from the input unit 201 as input. Furthermore, the deniable decryption key generation unit 202 transmits the deniable decryption key DSK to the deniable encryption key generation unit 203, the homomorphic operation key generation unit 206 and the transmission unit 207.

The deniable encryption key generation unit 203 generates a deniable encryption key DPK using the deniable decryption key DSK received from the deniable decryption key generation unit 202 as input. Furthermore, the deniable encryption key generation unit 203 transmits the deniable encryption key DPK to the transmission unit 207.

The multiple-key homomorphic decryption key generation unit 204 generates a multiple-key homomorphic decryption key MSK using the security parameter λ received from the input unit 201 as input. Furthermore, the multiple-key homomorphic decryption key generation unit 204 transmits the multiple-key homomorphic decryption key MSK to the multiple-key homomorphic encryption key generation unit 205 and the transmission unit 207.

The multiple-key homomorphic encryption key generation unit 205 generates a multiple-key homomorphic encryption key MPK using the multiple-key homomorphic decryption key MSK received from the multiple-key homomorphic decryption key generation unit 204 as input. Furthermore, the multiple-key homomorphic encryption key generation unit 205 transmits the multiple-key homomorphic encryption key MPK to the homomorphic operation key generation unit 206 and the transmission unit 207.

The homomorphic operation key generation unit 206 generates a homomorphic operation key EVK using the deniable decryption key DSK received from the deniable decryption key generation unit 202 and the multiple-key homomorphic encryption key MPK received from the multiple-key homomorphic encryption key generation unit 205 as input. Furthermore, the homomorphic operation key generation unit 206 transmits the homomorphic operation key EVK to the transmission unit 207.

The transmission unit 207 generates a decryption key SK=(DSK, MSK) from the deniable decryption key DSK generated by the deniable decryption key generation unit 202 and the multiple-key homomorphic decryption key MSK generated by the multiple-key homomorphic decryption key generation unit 204, and transmits the decryption key SK=(DSK, MSK) to the decryption device 600. Alternatively, the transmission unit 207 generates an encryption key PK from the deniable encryption key DPK generated by the deniable encryption key generation unit 203 and the multiple-key homomorphic encryption key MPK generated by the multiple-key homomorphic encryption key generation unit 205, and transmits the encryption key PK to the encryption device 300 and the denial random number generation device 400. Otherwise, the transmission unit 207 transmits the homomorphic operation key EVK generated by the homomorphic operation key generation unit 206 to the homomorphic operation device 500.

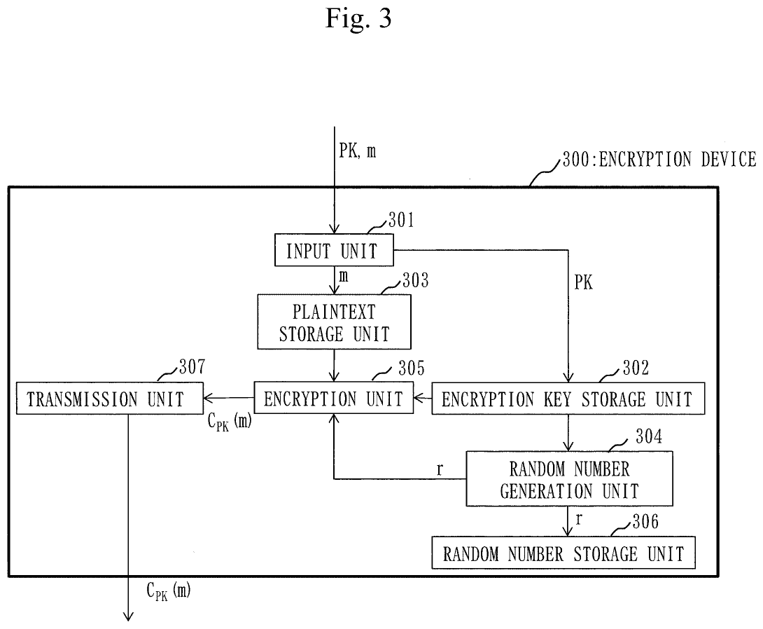

FIG. 3 is a block diagram illustrating the configuration of the encryption device 300 according to the present embodiment.

As illustrated in FIG. 3, the encryption device 300 is equipped with an input unit 301, an encryption key storage unit 302, a plaintext storage unit 303, a random number generation unit 304, an encryption unit 305, a random number storage unit 306 and a transmission unit 307, as functional elements.

In addition, although it is not illustrated, the encryption device 300 is equipped with a storage unit that stores data used in each unit of the encryption device 300.

The input unit 301 receives the encryption key PK transmitted from the key generation device 200, and transmits the encryption key PK to the encryption key storage unit 302. Alternatively, the input unit 301 receives plaintext data m, and transmits those pieces of plaintext data m to the plaintext storage unit 303.

The encryption key storage unit 302 stores the encryption key PK received from the input unit 301.

The plaintext storage unit 303 stores the plaintext data m received from the input unit 301.

The random number generation unit 304 generates random number data r from the encryption key PK stored in the encryption key storage unit 302, and transmits the random number data r to the encryption unit 305 and the random number storage unit 306.

The encryption unit 305 receives the encryption key PK transmitted from the encryption key storage unit 302, the plaintext data m transmitted from the plaintext storage unit 303, and the random number data r from the random number generation unit 304, and generates ciphertext data C_{PK}(m) of the plaintext data m. The encryption unit 305 then transmits the ciphertext data C_{PK}(m) to the transmission unit 307. Hereafter, C_{PK}(m) represents ciphertext data obtained by encrypting the plaintext data m with the encryption key PK.

The random number storage unit 306 stores the random number data r received from the random number generation unit 304.

The transmission unit 307 receives the ciphertext data C_{PK}(m) from the encryption unit 305 and transmits the ciphertext data C_{PK}(m) to the denial random number generation device 400 and the homomorphic operation device 500.

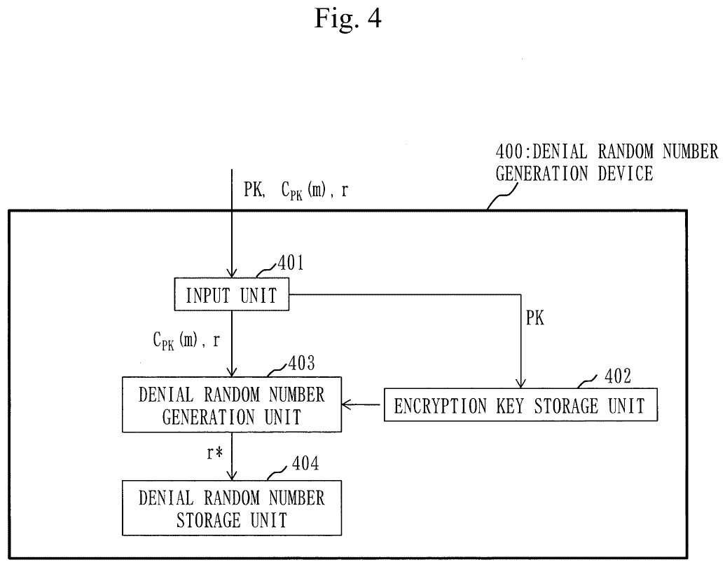

FIG. 4 is a block diagram illustrating the configuration of the denial random number generation device 400 according to the present embodiment.

As illustrated in FIG. 4, the denial random number generation device 400 is equipped with an input unit 401, an encryption key storage unit 402, a denial random number generation unit 403 and a denial random number storage unit 404, as functional elements

Furthermore, although it is not illustrated, the denial random number generation device 400 is equipped with a storage unit to store data used in each unit of the denial random number generation device 400.

The input unit 401 receives the encryption key PK transmitted from the key generation device 200, and transmits the encryption key PK to the encryption key storage unit 402. Alternatively, the input unit 401 receives the ciphertext data C_{PK}(m) and the random number data r transmitted from the encryption device 300, and transmits them to the denial random number generation unit 403.

The encryption key storage unit 402 stores the encryption key PK received from the input unit 401 of the denial random number generation device 400.

The denial random number generation unit 403 generates denial random number data r*, from the ciphertext data C_{PK}(m) and the random number data r received from the input unit 401, and the encryption key PK stored in the encryption key storage unit 402, and transmits the denial random number data r* to the denial random number storage unit 404.

The denial random number storage unit 404 stores the denial random number data r* received from the denial random number generation unit 403.

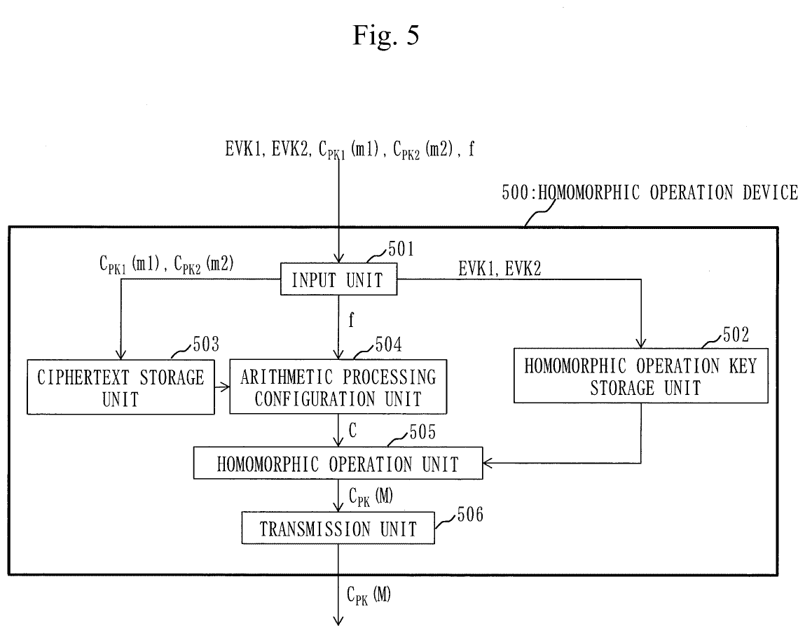

FIG. 5 is a block diagram illustrating the configuration of the homomorphic operation device 500 according to the present embodiment.

As illustrated in FIG. 5, the homomorphic operation device 500 is equipped with an input unit 501, a homomorphic operation key storage unit 502, a ciphertext storage unit 503, an arithmetic processing configuration unit 504, a homomorphic operation unit 505 and a transmission unit 506, as functional elements.

Additionally, although it is not illustrated, the homomorphic operation device 500 is equipped with a storage unit to store data used in each unit of the homomorphic operation device 500.

The input unit 501 receives homomorphic operation keys EVK1 and EVK2 transmitted from the key generation device 200, and transmits them to the homomorphic operation key storage unit 502. Alternatively, the input unit 501 receives ciphertext data C_{PK1} (m1) and C_{PK2} (m2) transmitted from the encryption device 300, and transmits them to the ciphertext storage unit 503. Otherwise, the input unit 501 receives an operation circuit f and transmits the operation circuit f to the arithmetic processing configuration unit 504.

The homomorphic operation key storage unit 502 stores the homomorphic operation keys EVK1 and EVK2 received from the input unit 501.

The ciphertext storage unit 503 stores the ciphertext data C_{PK1} (m1) and the ciphertext data C_{PK2} (m2) received from the input unit 501.

The arithmetic processing configuration unit 504 generates a homomorphic operation circuit C using the operation circuit f received from the input unit 501, and ciphertext data C_{PK1} (m1) and C_{PK2} (m2) received from the ciphertext storage unit 503 as input.

The homomorphic operation unit 505 receives the homomorphic operation keys EVK1 and EVK2 from the homomorphic operation key storage unit 502, and the homomorphic operation circuit C from the arithmetic processing configuration unit 504, calculates ciphertext data C_{PK}(M) related to operation result data M=f(m1, m2) obtained by applying the operation circuit f to the plaintext data m1 and the plaintext data m2, and transmits the ciphertext data C_{PK}(M) to the transmission unit 506. Here, f(m1, m2) represents the result of calculating the operation circuit f using two pieces of plaintext data m1 and m2 as input, whereas PK represents a set {PK1, PK2} constituted by encryption keys PK1 and PK2. Furthermore, in what follows, C_{PK}(M) represents the post-homomorphic operation ciphertext data of operation result data M related to the encryption key set PK={PK1, PK2}. The operation result data M can be decrypted from the post-homomorphic operation ciphertext data C_{PK}(M) by using the decryption keys SK1 and SK2.

The transmission unit 506 transmits the post-homomorphic operation ciphertext data C_{PK}(M) received from the homomorphic operation unit 505 to the decryption device 600.

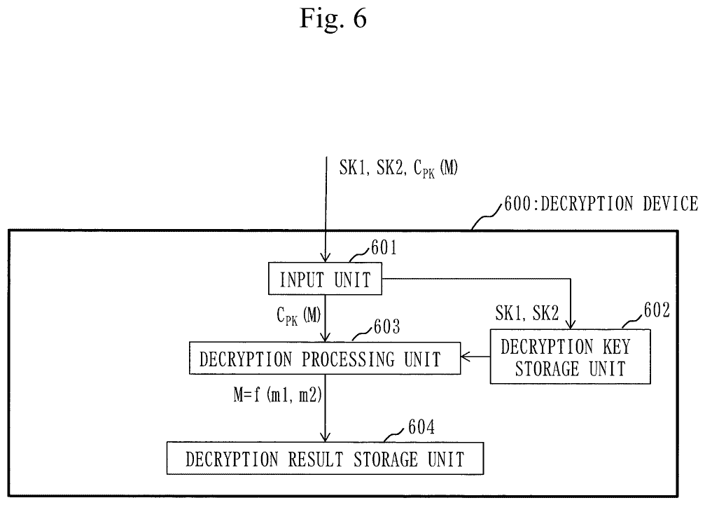

FIG. 6 is a block diagram illustrating the configuration of the decryption device 600 according to the present embodiment.

As illustrated in FIG. 6, the decryption device 600 is equipped with an input unit 601, a decryption key storage unit 602, a decryption processing unit 603 and a decryption result storage unit 604, as functional elements.

In addition, although it is not illustrated, the decryption device 600 is equipped with a storage unit to store data used in each unit of the decryption device 600.

The input unit 601 receives the decryption keys SK1 and SK2 transmitted from the key generation device 200. Alternatively, the input unit 601 receives the post-homomorphic operation ciphertext data C_{PK}(M) being the operation result data M related to the set of encryption keys PK={PK1, PK2} transmitted from the homomorphic operation device 500.

The decryption key storage unit 602 stores the decryption keys SK1 and SK2 received from the input unit 601.

The decryption processing unit 603 receives the post-homomorphic operation ciphertext data C_{PK}(M) from the input unit 601, and the decryption keys SK1 and SK2 from the decryption key storage unit 602. The decryption processing unit 603 decrypts the operation result data M which has been encrypted from the post-homomorphic operation ciphertext data C_{PK}(M) with the decryption keys SK1 and SK2, and transmits the operation result data M to the decryption result storage unit 604.

The decryption result storage unit 604 receives and stores the operation result data M from the decryption processing unit 603.

### ***Description of Operation***

Next, description will be made on the operation of the confidential information processing system 100 according to the present embodiment. The operation procedure of the confidential information processing system 100 corresponds to a confidential information processing method. Furthermore, a program that realizes the operation of the confidential information processing system 100 corresponds to a confidential information processing program.

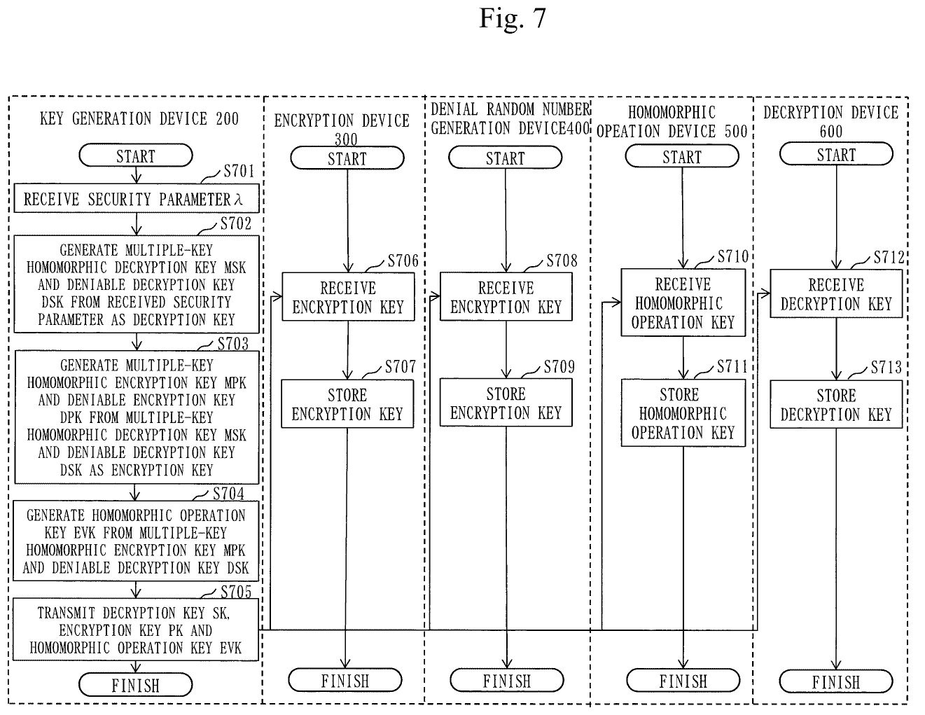

FIG. 7 is a flowchart illustrating the operation of each device in the confidential information processing system 100 according to the present embodiment.

The flowchart in FIG. 7 illustrates the generation and storage processing of encryption keys, decryption keys and homomorphic operation keys.

Step S701 through Step S713 in FIG. 7 illustrate processes executed by the key generation device 200, the encryption device 300, the denial random number generation device 400, the homomorphic operation device 500 and the decryption device 600.

The processes from Step S701 through Step S705 are executed by the key generation device 200.

The processes from Step S706 through Step S707 are executed by the encryption device 300.

The processes from Step S708 through Step S709 are executed by the denial random number generation device 400.

The processes from Step S710 through Step S711 are executed by the homomorphic operation device 500.

The processes from Step S712 through Step S713 are executed by the decryption device 600.

In Step S701, the input unit 201 in the key generation device 200 receives a security parameter λ.

In Step S702, the deniable decryption key generation unit 202 of the key generation device 200 generates a deniable decryption key DSK by using the security parameter λ received by the input unit 201 in the key generation device 200 in Step S701 as input. Furthermore, the multiple-key homomorphic decryption key generation unit 204 of the key generation device 200 generates a multiple-key homomorphic decryption key MSK by using the security parameter λ received by the input unit 201 in the key generation device 200 in Step S701 as input. The deniable decryption key DSK is generated by using the key generation algorithm described in Non-Patent Literature 1. In addition, the multiple-key homomorphic decryption key MSK is generated by using the key generation algorithm described in Non-Patent Literature 2.

In step S703, the deniable encryption key generation unit 203 of the key generation device 200 generates a deniable encryption key DPK by using the deniable decryption key DSK as input. Additionally, the multiple-key homomorphic encryption key generation unit 205 of the key generation device 200 generates a multiple-key homomorphic encryption key MPK by using the multiple-key homomorphic decryption key MSK as input. Here, the deniable encryption key DPK is generated by using the key generation algorithm described in Non-Patent Literature 1. Furthermore, the multiple-key homomorphic encryption key MPK is generated by using the key generation algorithm described in Non-Patent Literature 2.

In step S704, the homomorphic operation key generation unit 206 of the key generation device 200 outputs a multiple-key homomorphic ciphertext obtained by encrypting the deniable decryption key DSK using multiple-key homomorphic encryption, as the homomorphic operation key EVK. Specifically, the homomorphic operation key generation unit 206 generates the homomorphic operation key EVK in the format of (Formula 1) as follows, using the deniable decryption key DSK and the multiple-key homomorphic encryption key MPK as input.

$$EVK = Enc ( MPK , DSK ) \qquad ( Formula 1 )$$

Here, the algorithm Enc is an encryption algorithm described in Non-Patent Literature 2.

In Step S705, the transmission unit 207 of the key generation device 200 generates a decryption key SK, which is represented in the format of (Formula 2) as follows, from the deniable decryption key DSK and the multiple-key homomorphic decryption key MSK. Furthermore, the transmission unit 207 of the key generation device 200 generates an encryption key PK, which is represented in format of (Formula 3) as follows, from the deniable encryption key DPK and the multiple-key homomorphic encryption key MPK.

$$SK = ( DSK , MSK ) \qquad ( Formula 2 )$$

$$PK = ( DPK , MPK ) \qquad ( Formula 3 )$$

The transmission unit 207 in the key generation device 200 transmits the encryption key PK to the encryption device 300 and the denial random number generation device 400. Additionally, the transmission unit 207 in the key generation device 200 transmits the homomorphic operation key EVK, which is generated by the homomorphic operation key generation unit 206 in the key generation device 200, to the homomorphic operation device 500. Furthermore, the transmission unit 207 in the key generation device 200 transmits the decryption key SK to the decryption device 600.

In Step S706, the input unit 301 in the encryption device 300 receives the encryption key PK transmitted by the transmission unit 207 of the key generation device 200 in Step S705.

In step S707, the encryption key storage unit 302 in the encryption device 300 stores the encryption key PK received by the input unit 301 in the encryption device 300 in Step S706.

In Step S708, the input unit 401 in the denial random number generation device 400 receives the encryption key PK transmitted by the transmission unit 207 in the key generation device 200 in Step S705.

In Step S709, the encryption key storage unit 402 in the denial random number generation device 400 stores the encryption key PK received by the input unit 401 in the denial random number generation device 400 in Step S708.

In Step S710, the input unit 501 in the homomorphic operation device 500 receives the homomorphic operation key EVK transmitted by the transmission unit 207 in the key generation device 200 in Step S705.

In Step S711, the homomorphic operation key storage unit 502 in the homomorphic operation device 500 stores the homomorphic operation key EVK received by the input unit 501 in the homomorphic operation device 500 in Step S710.

In Step S712, the input unit 601 in the decryption device 600 receives the decryption key SK transmitted by the transmission unit 207 in the key generation device 200 in Step S705.

In Step S713, the decryption key storage unit 602 in the decryption device 600 stores the decryption key SK received by the input unit 601 in the decryption device 600 in Step S712.

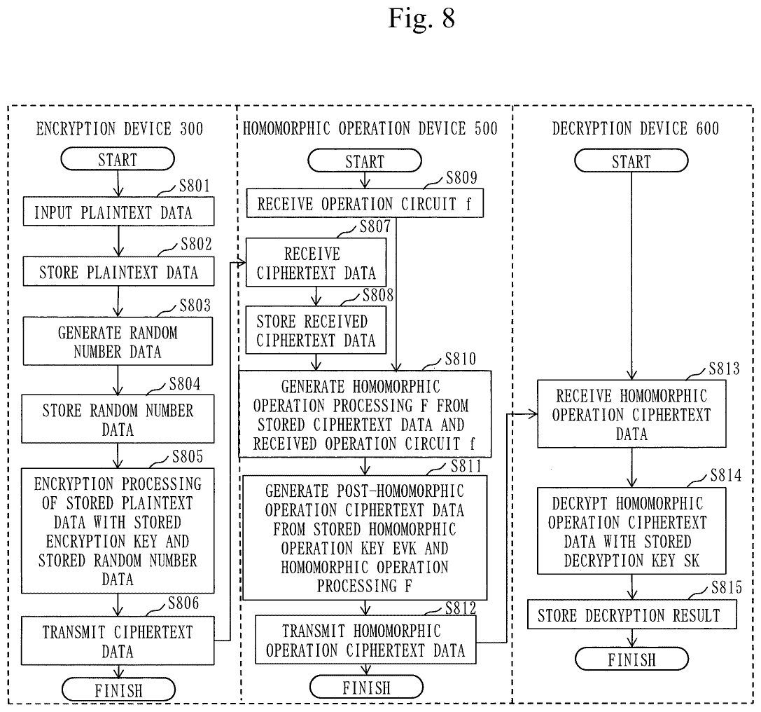

FIG. 8 is a flowchart illustrating the homomorphic operation in the confidential information processing system 100 according to the present embodiment.

The processes from Step S801 through Step S815 in FIG. 8 are executed by the encryption device 300, the homomorphic operation device 500 and the decryption device 600.

The processes from Step S801 through Step S806 are executed by the encryption device 300.

The processes from Step S807 to Step S812 are executed by the homomorphic operation device 500.

The processes from Step S807 through Step S815 are executed by the decryption device 600.

In Step S801, the input unit 301 in the encryption device 300 receives plaintext data m1 and m2 collected from, for instance, a sensor or the like, and transmits the plaintext data m1 and m2 to the plaintext storage unit 303.

In Step S802, the plaintext storage unit 303 in the encryption device 300 stores the plaintext data m1 and m2 received from the input unit 301 in the encryption device 300.

In Step S803, the random number generation unit 304 in the encryption device 300 generates random number data r1 and r2, and transmits them to the random number storage unit 306 in the encryption device 300.

In Step S804, the random number storage unit 306 in the encryption device 300 stores the random number data r1 and r2 received from the random number generation unit 304 in the encryption device 300.

In Step S805, the encryption unit 305 in the encryption device 300 generates ciphertext data C_{DPK1} (m1) from the deniable encryption key DPK1 stored in the encryption key storage unit 302 in the encryption device 300, the random number data r1 stored in the random number storage unit 306, and the plaintext data m1 stored in the plaintext storage unit 303. Furthermore, the encryption unit 305 in the encryption device 300 generates ciphertext data C_{DPK2} (m2) from the deniable encryption key DPK2 stored in the encryption key storage unit 302 in the encryption device 300, the random number data r2 stored in the random number storage unit 306, and the plaintext data m2 stored in the plaintext storage unit 303. The ciphertext data C_{DPK1} (m1) and C_{DPK2} (m2) are transmitted to the transmission unit 307 of the encryption device 300.

In step S806, the transmission unit 307 in the encryption device 300 receives the ciphertext data C_{DPK1} (m1) and C_{DPK2} (m2) transmitted by the encryption unit 305 in Step S805, and transmits them to the homomorphic operation device 500.

In Step S807, the input unit 501 in the homomorphic operation device 500 receives the ciphertext data C_{DPK1} (m1) and C_{DPK2} (m2) transmitted from the transmission unit 307 in the encryption device 300, and transmits them to the ciphertext storage unit 503.

In Step S808, the ciphertext storage unit 503 in the homomorphic operation device 500 receives the ciphertext data C_{DPK1} (m1) and C_{DPK2} (m2) transmitted from the input unit 501 in the homomorphic operation device 500 in Step S807, and stores them.

In Step S809, the input unit 501 in the homomorphic operation device 500 receives the operation circuit f inputted from a keyboard, mouse, storage device or the like, and transmits the operation circuit f to the arithmetic processing configuration unit 504.

In Step S810, the arithmetic processing configuration unit 504 in the homomorphic operation device 500 generates a homomorphic operation processing circuit F represented in the format of (Formula 4) as follows, using as input the ciphertext data C_{DPK1} (m1) and C_{DPK2} (m2) stored in the ciphertext storage unit 503 in the homomorphic operation device 500 in Step S808, and the operation circuit f transmitted from the input unit 501 in the homomorphic operation device 500 in Step S809. The homomorphic operation processing circuit F is transmitted to the homomorphic operation unit 505 in the homomorphic operation device 500.

F(DSK1,DSK2)=f(Dec(DSK1,C_{DPK1}(m1)),Dec(DSK2,C_{DPK2}(m2))) (Formula 4)

Here, the algorithm Dec is the decryption algorithm described in Non-Patent Literature 1.

In the homomorphic operation device 500, during the homomorphic operation, ciphertext data is converted from a deniable ciphertext to a multiple-key homomorphic ciphertext by performing decryption processing of deniable homomorphic encryption while the ciphertext data remains encrypted.

In Step S811, the homomorphic operation unit 505 in the homomorphic operation device 500 generates post-homomorphic operation ciphertext data C_{MPK} (M) by the use of the homomorphic operation algorithm described in Non-Patent Literature 2, using the homomorphic operation key EVK and the homomorphic operation processing circuit F as input, and, and transmits the post-homomorphic operation ciphertext data C_{MPK} (M) to the transmission unit 506.

In Step S812, the transmission unit 506 in the homomorphic operation device 500 transmits the post-homomorphic operation ciphertext data C_{MPK} (M) to the decryption device 600.

In Step S813, the input unit 601 in the decryption device 600 receives the post-homomorphic operation ciphertext data C_{MPK} (M) transmitted from the transmission unit 506 in the homomorphic operation device 500 in Step S812, and transmits the post-homomorphic operation ciphertext data C_{MPK} (M) to the decryption processing unit 603.

In Step S814, the decryption processing unit 603 in the decryption device 600 uses the post-homomorphic operation ciphertext data C_{MPK} (M) transmitted from the input unit 601 in the decryption device 600 in Step S813, and the decryption keys MSK1 and MSK2 stored in the decryption key storage unit 602 in the decryption device 600 to perform decryption processing, and obtains the decryption result M. Here, it is possible to decrypt the decryption result M=f(m1, m2) for the encryption key set MPK={MPK1, MPK2} of the post-homomorphic operation ciphertext data C_{MPK} (M) only when the multiple-key homomorphic encryption key MPK1 is generated by the multiple-key homomorphic encryption key generation unit 205 by using the multiple-key homomorphic decryption key MSK1 as input, and the multiple-key homomorphic encryption key MPK2 is generated by the multiple-key homomorphic encryption key generation unit 205 by using the multiple-key homomorphic decryption key MSK2 as input. The decryption processing unit 603 transmits the decryption result M to the decryption result storage unit 604.

In Step S815, the decryption result storage unit 604 in the decryption device 600 stores the decryption result M, which has been transmitted from the decryption processing unit 603 in the decryption device 600 in Step S814.

Note that the decryption device 600 accepts only a post-homomorphic operation ciphertext as input. However, if it is desired to decrypt a pre-homomorphic operation ciphertext, by requiring the homomorphic operation device 500 to perform a homomorphic operation with respect to an operation to output the same value as the input, and decrypting the post-homomorphic operation ciphertext obtained in the same manner as in the process in Step S814, the plaintext data of the pre-homomorphic operation ciphertext can be decrypted.

With Step S815, the homomorphic operation processing in the confidential information processing system 100 ends.

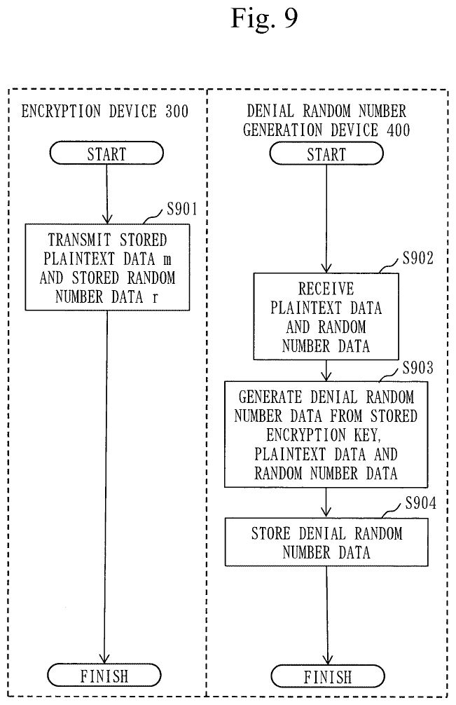

FIG. 9 is a flowchart illustrating the homomorphic operation of the confidential information processing system 100 according to the present embodiment.

The processes from Step S901 through Step S904 of FIG. 9 are performed by the encryption device 300 and the denial random number generation device 400.

The process in Step S901 is performed by the encryption device 300.

The processes from Step S902 through Step S904 are performed by the denial random number generation device 400.

In Step S901, the transmission unit 307 in the encryption device 300 transmits the plaintext data m1 and m2 that are stored in the plaintext storage unit 303 in the encryption device 300 together with the random number data r1 and r2 that are stored in the random number storage unit 306 in the encryption device 300 to the denial random number generation device 400.

In Step S902, the input unit 401 in the denial random number generation device 400 receives the plaintext data m1 and m2, and the random number data r1 and r2 that have been transmitted from the transmission unit 307 in the encryption device 300 in Step S901, and transmits them to the denial random number generation unit 403 in the denial random number generation device 400.

In Step S903, the denial random number generation unit 403 in the denial random number generation device 400 receives the plaintext data m1 and the random number data r1 received from the input unit 401 in the denial random number generation device 400 in Step S902, and generates denial random number data r1*. Additionally, the denial random number generation unit 403 in the denial random number generation device 400 receives the plaintext data m2 and the random number data r2 received from the input unit 401 in the denial random number generation device 400 in Step S902, and generates denial random number data r2*. These denial random number data r1* and r2* are transmitted to the denial random number storage unit 404 in the denial random number generation device 400.

In Step S904, the denial random number storage unit 404 in the denial random number generation device 400 stores the denial random number data r1* and r2* received from the denial random number generation unit 403 in the denial random number generation device 400 in Step S903.

In the present embodiment, the confidential information processing system 100 as follows has been described.

The key generation device 200 generates a first deniable encryption key and a first deniable decryption key, and a second deniable encryption key and a second deniable decryption key, which are used in deniable encryption. Each of the set of the first deniable encryption key and the first deniable decryption key, and the set of the second deniable encryption key and the second deniable decryption key is a separate key generated by different users. Furthermore, the key generation device 200 generates a first multiple-key homomorphic encryption key and a first multiple-key homomorphic decryption key, and a second multiple-key homomorphic encryption key and a second multiple-key homomorphic decryption key, which are used in multiple-key homomorphic encryption. In addition, the key generation device 200 generates a first homomorphic operation key from the first deniable decryption key and the first multiple-key homomorphic encryption key. Additionally, the key generation device 200 generates a second homomorphic operation key from the second deniable decryption key and the second multiple-key homomorphic encryption key.

The encryption device 300 encrypts the first plaintext data with the first deniable encryption key to produce first ciphertext data. The encryption device 300 further encrypts the second plaintext data with the second deniable encryption key to produce second ciphertext data.

The denial random number generation device 400 generates first denial random number data for denying the disclosure of the first plaintext data, using the first deniable encryption key and the first ciphertext data as input. Moreover, the denial random number generation device 400 generates second denial random number data for denying the disclosure of the second plaintext data, using the second deniable encryption key and the second ciphertext data as input.

The homomorphic operation device 500 generates post-homomorphic encryption ciphertext data obtained by performing a homomorphic operation over the calculation results of the first plaintext data and the second plaintext data, using the first homomorphic operation key the second homomorphic operation key, and the first ciphertext data and the second ciphertext data as input.

The decryption device 600 decrypts the post-homomorphic encryption ciphertext data using the first deniable decryption key and the second deniable decryption key.

### ***Description of Hardware Configuration***

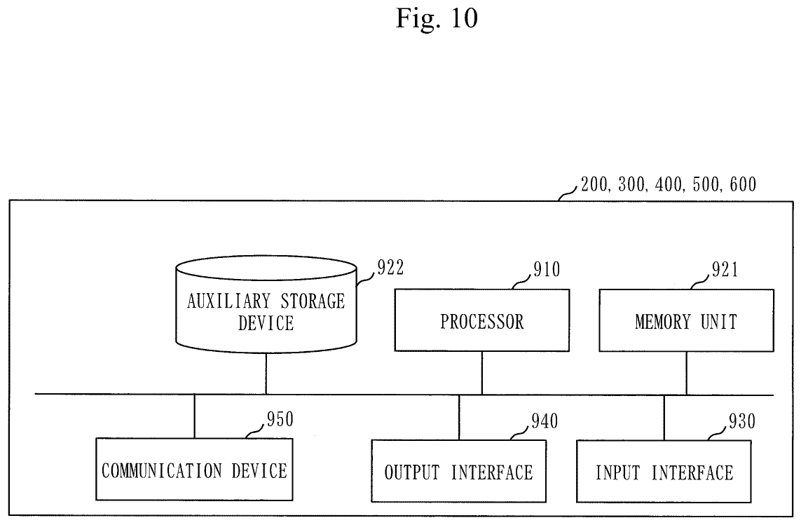

FIG. 10 is a diagram illustrating an example of the hardware configuration for each device of the confidential information processing system 100 according to the present embodiment.

Hereafter, each of the key generation device 200, the encryption device 300, the denial random number generation device 400, the homomorphic operation device 500, and the decryption device 600 may be referred to as each device of the confidential information processing system 100.

Each device of the confidential information processing system 100 is a computer. Each device of the confidential information processing system 100 is equipped with a processor 910, and also other hardware components such as a memory unit 921, an auxiliary storage device 922, an input interface 930, an output interface 940, and a communication device 950. The processor 910 is connected to the other hardware components via signal lines and controls these other hardware components.

As described in FIG. 2 through FIG. 6, each device of the confidential information processing system 100 is equipped with functional elements.

The functional elements of each device in the confidential information processing system 100 are realized by software. Furthermore, the storage parts of each device in the confidential information processing system 100 are provided in the memory unit 921. Note that the storage parts may also be provided in the auxiliary storage device 922, or may be provided dispersively in the memory unit 921 and the auxiliary storage device 922.

The processor 910 is a device that executes the confidential information processing program. The confidential information processing program is a program that realizes the functional elements of each device in the confidential information processing system 100.

The processor 910 is an IC that performs arithmetic processing. A concrete example of the processor 910 is a CPU, a DSP, or a GPU. IC is an abbreviation for Integrated Circuit. CPU is an abbreviation for Central Processing Unit. DSP is an abbreviation for Digital Signal Processor. GPU is an abbreviation for Graphics Processing Unit.

The memory unit 921 is a storage device that temporarily stores data. A concrete example of the memory unit 921 is an SRAM or a DRAM. SRAM is an abbreviation for Static Random Access Memory. DRAM is an abbreviation for Dynamic Random Access Memory.

The auxiliary storage device 922 is a storage device that preserves data. A concrete example of the auxiliary storage device 922 is an HDD. Furthermore, the auxiliary storage device 922 may also be a portable storage medium such as an SD (registered trademark) memory card, a CF, a NANDflash, a flexible disk, an optical disc, a compact disk, a Blu-ray (registered trademark) disk, or a DVD. Note that HDD is an abbreviation for Hard Disk Drive. SD (registered trademark) is an abbreviation for Secure Digital. CF is an abbreviation for CompactFlash (registered trademark). DVD is an abbreviation for Digital Versatile Disk.

The input interface 930 is a port that is connected to an input device such as a mouse, a keyboard, or a touch panel. The input interface 930 is, for example, a USB terminal. However, the input interface 930 may also be a port that is connected to a LAN. USB is an abbreviation for Universal Serial Bus. LAN is an abbreviation for Local Area Network.

The output interface 940 is a port to which a cable of an output device such as a display is connected. The output interface 940 is, for example, a USB terminal or an HDMI (registered trademark) terminal. The display is, for example, an LCD. The output interface 940 is also referred to as a display interface. HDMI (registered trademark) is an abbreviation for High Definition Multimedia Interface. LCD is an abbreviation for Liquid Crystal Display.

The communication device 950 is equipped with a receiver and a transmitter. The communication device 950 is connected to communication networks such as LAN, the internet, telephone lines, or Wi-Fi (registered trademark). The communication device 950 is, for example, a communication chip or an NIC. NIC is an abbreviation for Network Interface Card.

The confidential information processing program is executed in the confidential information processing system 100. The confidential information processing program is loaded into the processor 910, and executed by the processor 910. In the memory unit 921, not only the confidential information processing program but also the OS is stored. OS is the abbreviation for Operating System. The processor 910 executes the confidential information processing program while executing the OS. The confidential information processing program and the OS may be stored in the auxiliary storage device 922. The confidential information processing program and the OS stored in the auxiliary storage device 922 are loaded into the memory unit 921, and executed by the processor 910. Additionally, all or part of the confidential information processing program may be integrated into the OS.

The confidential information processing system 100 may also be equipped with multiple processors to replace the processor 910. These multiple processors share the execution of the confidential information processing program. Each of these processors is a device that executes the confidential information processing program in the same manner as the processor 910.

The data, information, signal values, and variable values utilized, processed, or outputted by the confidential information processing program are stored in the memory unit 921, the auxiliary storage device 922, or in a register or cache memory within the processor 910.

The “unit” of each unit of the functional elements of each device in the confidential information processing system 100 may be replaced with “circuit”, “step”, “procedure”, “process” or “circuitry”. The confidential information processing program causes a computer to perform a “process” that substitutes for “unit” of each unit being the functional element of each device in the confidential information processing system 100. The “unit” of each unit being the functional element of each device in the confidential information processing system 100 may be replaced with “program”, “program product”, “computer-readable storage medium storing programs” or “computer-readable recording medium recording programs”. Further, the confidential information processing method is a method performed by executing the confidential information processing program by the confidential information processing system 100.

The confidential information processing program may be stored and provided in a computer-readable recording medium. Furthermore, the confidential information processing program may be provided as a program product.

### ***Other Configurations***

In the present embodiment, functional elements of each device in the confidential information processing system 100 are realized by software. As a variation, the functional elements of each device in the confidential information processing system 100 may also be realized by hardware components.

Specifically, each device in the confidential information processing system 100 may be equipped with an electronic circuit 909 instead of the processor 910.

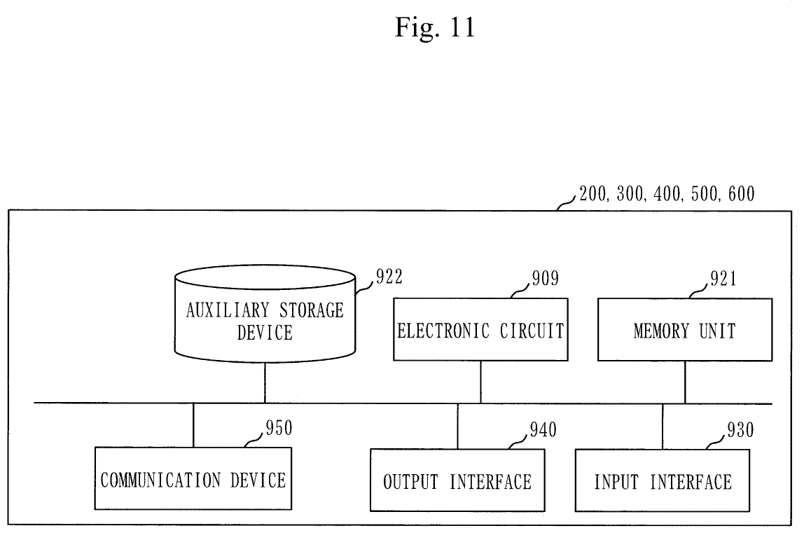

FIG. 11 is a diagram illustrating an example of hardware configuration of each device in the confidential information processing system 100 according to a variation of the present embodiment.

The electronic circuit 909 is a dedicated electronic circuit that realizes the functional elements of each device in the confidential information processing system 100. The electronic circuit 909 is, for example, a single circuit, a compound circuit, a programmed processor, a parallel programmed processor, a logic IC, a GA, an ASIC, or an FPGA. GA is an abbreviation for Gate Array. ASIC is an abbreviation for Application Specific Integrated Circuit. FPGA is an abbreviation for Field-Programmable Gate Array.

The functional elements of each device of the confidential information processing system 100 may be realized by a single electronic circuit, or may be dispersively realized by multiple electronic circuits.

As another variation, some functions of the functional elements of each device in the confidential information processing system 100 may be realized by an electronic circuit, and the remaining functions may be realized by software. In addition, some or all of the functions of the functional elements of each device in the confidential information processing system 100 may be realized by firmware.

Each processor and electronic circuit is also referred to as processing circuitry. In other words, the functional elements of each device in the confidential information processing system 100 are realized by the processing circuitry.

### ***Description of Effects of Present Embodiment***

The confidential information processing system according to the present embodiment has effects as follows, for instance.

In general, when assuming the delegation of analysis processing to a cloud using homomorphic encryption, it suffices to establish deniability only for the ciphertext before the analysis processing, and the ciphertext after the analysis processing needs not be a homomorphic encryption ciphertext with deniability.

In the confidential information processing system according to the present embodiment, by combining a homomorphic encryption with deniability and a multiple-key homomorphic encryption, the system is equipped with the function to allow the analysis processing even on data to data that have been encrypted with different keys while guaranteeing deniability.

In the confidential information processing system according to the present embodiment, so as to combine the homomorphic encryption with deniability and the multiple-key homomorphic encryption, a special analysis processing circuit to perform analysis processing while converting the ciphertext of homomorphic encryption with deniability to the ciphertext of multiple-key homomorphic encryption is designed, thus enabling analysis processing on data to data that are encrypted with different keys while maintaining the deniability.

In this manner, it is possible to provide a homomorphic encryption that allows analysis processing on data to data that are encrypted with different keys. Furthermore, it is sufficient for ciphertext data to be encrypted only with the key of the creator of the ciphertext data, which has an effect to contribute to the improvement of efficiency.

In general, since plaintext data is encrypted using homomorphic encryption where homomorphic operation can be performed only on data to data that are encrypted therein with the same key, homomorphic operation cannot be performed on data to data that are encrypted with different keys. With the confidential information processing system according to the present embodiment, it is possible to perform homomorphic operation between ciphertext data that are generated with different encryption keys.

Furthermore, with the confidential information processing system according to the present embodiment, homomorphic operation can be performed between ciphertext data that are generated with different encryption keys; therefore, it is possible to delegate analysis processing to a cloud server in a smaller data size of ciphertext. In general, since homomorphic encryption can be performed only on data to data that are encrypted with the same key, it is necessary for a creator of ciphertext data to encrypt the own plaintext data with a key of another creator of ciphertext data, which makes the size of the ciphertext data extremely large. The confidential information processing system according to the present embodiment has the effect to contribute to the improvement of efficiency since it is unnecessary to generate ciphertext data with a key of another creator of ciphertext data.

As described above, the confidential information processing system according to the present embodiment can provide homomorphic encryption capable of performing analysis processing on data to data that are encrypted with different keys by skillfully combining two types of encryption technologies, namely, deniable encryption and multiple-key homomorphic encryption. Furthermore, it is sufficient that the ciphertext data is encrypted with only the key of the creator of the ciphertext data, which also has the effect to contribute to improvement of efficiency.

In the first embodiment above, each unit of each device in the confidential information processing system has been described as an independent functional block. However, the structure of each device in the confidential information processing system may not necessarily be the configuration as described in the embodiment above. The functional blocks of each device in the confidential information processing system may have any configuration as long as they can realize the functions described in the embodiment above. Further, each device in the confidential information processing system may be a system composed of multiple devices rather than a single device.

Furthermore, multiple parts of the first embodiment may be combined and implemented. Otherwise, a part of the embodiment may be implemented. Alternatively, the embodiment may be implemented in any combination, in whole or in part.

That is, in the first embodiment, it is possible to freely combine each embodiment, modify an arbitrary component of each embodiment, or omit an arbitrary component in each embodiment.

Note that the embodiment described above is essentially a preferable example, and is not intended to limit the scope of the present disclosure, the scope of application of the present disclosure, nor the range of uses of the present disclosure. Various modifications can be made to the embodiment described above. For example, the procedures described using a flowchart or a sequence diagram can be appropriately altered.

### REFERENCE SIGNS LIST

100: confidential information processing system; 101: the internet; 200: key generation device; 201, 301, 401, 501, 601: input unit; 202: deniable decryption key generation unit; 203: deniable encryption key generation unit; 204: multiple-key homomorphic decryption key generation unit; 205: multiple-key homomorphic encryption key generation unit; 206: homomorphic operation key generation unit; 207, 307, 506: transmission unit; 300: encryption device; 302, 402: encryption key storage unit; 303: plaintext storage unit; 304: random number generation unit; 305: encryption unit; 306: random number storage unit; 400: denial random number generation device; 403: denial random number generation unit; 404: denial random number storage unit; 500: homomorphic operation device; 502: homomorphic operation key storage unit; 503: ciphertext storage unit; 504: arithmetic processing configuration unit; 505: homomorphic operation unit; 600: decryption device; 602: decryption key storage unit; 603: decryption processing unit; 604: decryption result storage unit; 909: electronic circuit; 910: processor; 921: memory unit; 922: auxiliary storage device; 930: input interface; 940: output interface; 950: communication device.

1. A confidential information processing system comprising:
a key generation device to generate an encryption key, a decryption key, and a homomorphic operation key;
an encryption device to generate ciphertext data by encrypting plaintext data with the encryption key;
a denial random number generation device to generate denial random number data for denying disclosure of the plaintext data by using the encryption key and ciphertext data as input;
a homomorphic operation device to generate post-homomorphic operation ciphertext data by performing a homomorphic operation on a calculation result of the plaintext data by using the homomorphic operation key and the ciphertext data as input; and
a decryption device to decrypt the post-homomorphic operation ciphertext data.

2. The confidential information processing system as defined in claim 1, wherein the key generation device outputs a deniable encryption key used in deniable encryption and a multiple-key homomorphic encryption key used in multiple-key homomorphic encryption, as the encryption key.

3. The confidential information processing system as defined in claim 2, wherein the key generation device outputs a deniable decryption key used in deniable encryption and a multiple-key homomorphic decryption key used in multiple-key homomorphic encryption, as the decryption key.

4. The confidential information processing system as defined in claim 3, wherein the key generation device outputs a multiple-key homomorphic ciphertext obtained by encrypting the deniable decryption key with multiple-key homomorphic encryption, as the homomorphic operation key.

5. The confidential information processing system as defined in claim 4, wherein the homomorphic operation device converts the ciphertext data from a deniable ciphertext into the multiple-key homomorphic ciphertext by performing a decryption process of deniable homomorphic encryption while the ciphertext data remains encrypted, during the homomorphic operation.

6. A confidential information processing method used in a confidential information processing system, the confidential information processing method comprising:
by a key generation device, generating an encryption key, a decryption key, and a homomorphic operation key;
by an encryption device, generating ciphertext data by encrypting plaintext data with the encryption key;
by a denial random number generation device, generating denial random number data for denying disclosure of the plaintext data by using the encryption key and ciphertext data as input;
by a homomorphic operation device, generating post-homomorphic operation ciphertext data by performing a homomorphic operation on a calculation result of the plaintext data by using the homomorphic operation key and the ciphertext data as input; and
by a decryption device, decrypting the post-homomorphic operation ciphertext data.

7. A non-transitory computer readable medium storing a confidential information processing program to cause a computer to perform:
a key generation process to generate an encryption key, a decryption key, and a homomorphic operation key;
an encryption process to generate ciphertext data by encrypting plaintext data with the encryption key;
a denial random number generation process to generate denial random number data for denying disclosure of the plaintext data by using the encryption key and ciphertext data as input;
a homomorphic operation process to generate post-homomorphic operation ciphertext data by performing a homomorphic operation on a calculation result of the plaintext data by using the homomorphic operation key and the ciphertext data as input; and
a decryption process to decrypt the post-homomorphic operation ciphertext data.
